(19) United States
(12) Patent Application Publication
(10) Pub. No.: US 2023/0065949 A1
(43) Pub. Date: Mar. 2, 2023

(54) AUGMENTED REALITY PHYSICAL STORAGE VALIDATION

(71) Applicant: KYNDRYL, INC., New York, NY (US)

(72) Inventors: RESHMA REDDY RAMIREDDY, Leander, TX (US); CARLOS DANIEL TREJO MARTINEZ, Austin, TX (US); Zachary A. Silverstein, Austin, TX (US); Jennifer M. Hatfield, San Francisco, CA (US); Al Chakra, Apex, NC (US)

(21) Appl. No.: 17/460,371

(22) Filed: Aug. 30, 2021

(51) Int. Cl. G06F 21/55; G06F 16/13; G10L 15/22; G06T 11/00

(52) U.S. Cl. CPC G06F 21/55; G06F 16/13; G10L 15/22; G06T 11/00; G06F 2221/034; G10L 2015/223

(57) ABSTRACT

One or more computer processors detect a physical storage device within a visual proximity to a user within an augmented reality (AR) environment. The one or more computer processors capture one or more physical identifiers of the detected physical storage device. The one or more computer processors identify an indexed filesystem associated with the physical storage device utilizing the one or more captured physical identifiers, wherein the indexed filesystem contains metadata representing file content stored on the physical storage device. The one or more computer processors calculate a filesystem risk score associated with the physical storage device utilizing the identified physical identifiers. The one or more computer processors present generated graphics representing the indexed filesystem and the calculated filesystem risk score to the user within an AR viewport.

### BACKGROUND

The present invention relates generally to the field of augmented reality, and more particularly to physical storage recognition.

Augmented reality (AR) is an interactive experience of a real-world environment where the objects that reside in the real world are enhanced by computer-generated perceptual information, sometimes across multiple sensory modalities, including visual, auditory, haptic, somatosensory and olfactory. AR can be defined as a system that incorporates three basic features: a combination of real and virtual worlds, real-time interaction, and accurate 3D registration of virtual and real objects. The overlaid sensory information can be constructive (i.e., additive to the natural environment), or destructive (i.e., masking of the natural environment). This experience is seamlessly interwoven with the physical world such that it is perceived as an immersive aspect of the real environment.

### SUMMARY

Embodiments of the present invention disclose a computer-implemented method, a computer program product, and a system. The computer-implemented method includes one or more computer processers detecting a physical storage device within a visual proximity to a user within an augmented reality (AR) environment. The one or more computer processors capture one or more physical identifiers of the detected physical storage device. The one or more computer processors identify an indexed filesystem associated with the physical storage device utilizing the one or more captured physical identifiers, wherein the indexed filesystem contains metadata representing file content stored on the physical storage device. The one or more computer processors calculate a filesystem risk score associated with the physical storage device utilizing the identified physical identifiers. The one or more computer processors present generated graphics representing the indexed filesystem and the calculated filesystem risk score to the user within an AR viewport.

### BRIEF DESCRIPTION OF THE DRAWINGS

FIG. 1 (i.e., FIG.) is a functional block diagram illustrating a distributed data processing environment, in accordance with an embodiment of the present invention;

FIG. 2 is a flowchart depicting operational steps of a program, on a computing device within the data processing environment of FIG. 1, for risk of change analysis with visually captured physical storage devices, in accordance with an embodiment of the present invention; and

FIG. 3 is a block diagram of components of a computing device, in accordance with an embodiment of the present invention.

### DETAILED DESCRIPTION

Traditionally, enterprise users utilize multiple physical storage devices during the course of work and frequently the physical storage devices are older devices. Enterprises have significant difficulty maintaining strict data security standards while tracking files and assessing the authenticity of a physical storage device filesystem (i.e., data contained on the physical storage device). Standard enterprise data security systems are costly and computationally prohibitive and said costs and computational requirements increase as enterprises scale. In addition, costs are amplified due to increased system complexity when filesystems contained on the enterprise physical storage devices are outdated, lost and/or potentially tampered.

Embodiments of the present invention provide physical storage device tracing and data validation in an augmented reality (AR) environment. Embodiments of the present invention allow one or more users an ability to view data integrity and confidence values for associated physical storage devices (e.g., active (i.e., powered or connected) or inactive) without having to manually inspected or otherwise assess stored filesystem contents. Embodiments of the present invention provide a solution for viewing the filesystem contained in a physical storage device prior to physical storage device utilization. Embodiments of the present invention provide validate the integrity of a filesystem based on a calculated risk score utilizing physical storage device block tree version changes. Embodiments of the present invention reduce computational requirements by providing a distributed enterprise data security system within an AR environment. Implementation of embodiments of the invention may take a variety of forms, and exemplary implementation details are discussed subsequently with reference to the Figures.

The present invention will now be described in detail with reference to the Figures.

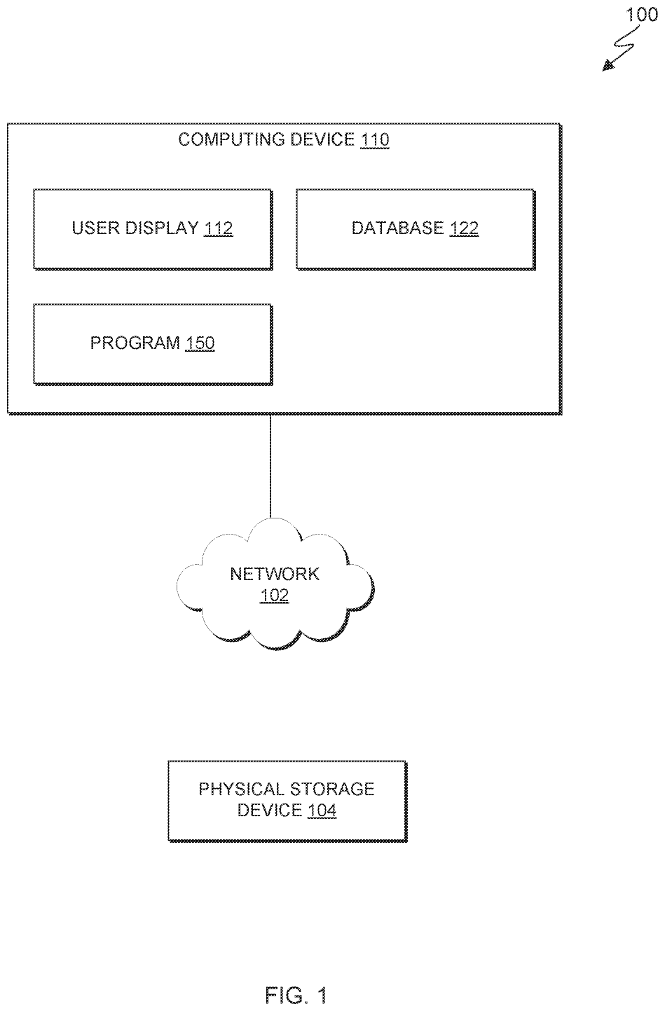

FIG. 1 is a functional block diagram illustrating a distributed data processing environment, generally designated 100, in accordance with one embodiment of the present invention. The term “distributed” as used in this specification describes a computer system that includes multiple, physically, distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes computing device 110 connected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between computing device 110 and other computing devices (not shown) within distributed data processing environment 100. In various embodiments, network 102 operates locally via wired, wireless, or optical connections and can be any combination of connections and protocols (e.g., personal area network (PAN), near field communication (NFC), laser, infrared, ultrasonic, etc.).

Physical storage device 104 may be any non-volatile storage where contents persist even when power is switched off or the storage is disconnected. Physical storage device 104 can be, for example, cache, flash memory, magnetic disk(s), magnetic tape, optical storage, Serial ATA (SATA) drive, etc. In an embodiment, physical storage device 104 is labeled with a quick response (QR) code or radio-frequency identification (RFID) tag that is associated with an indexed filesystem.

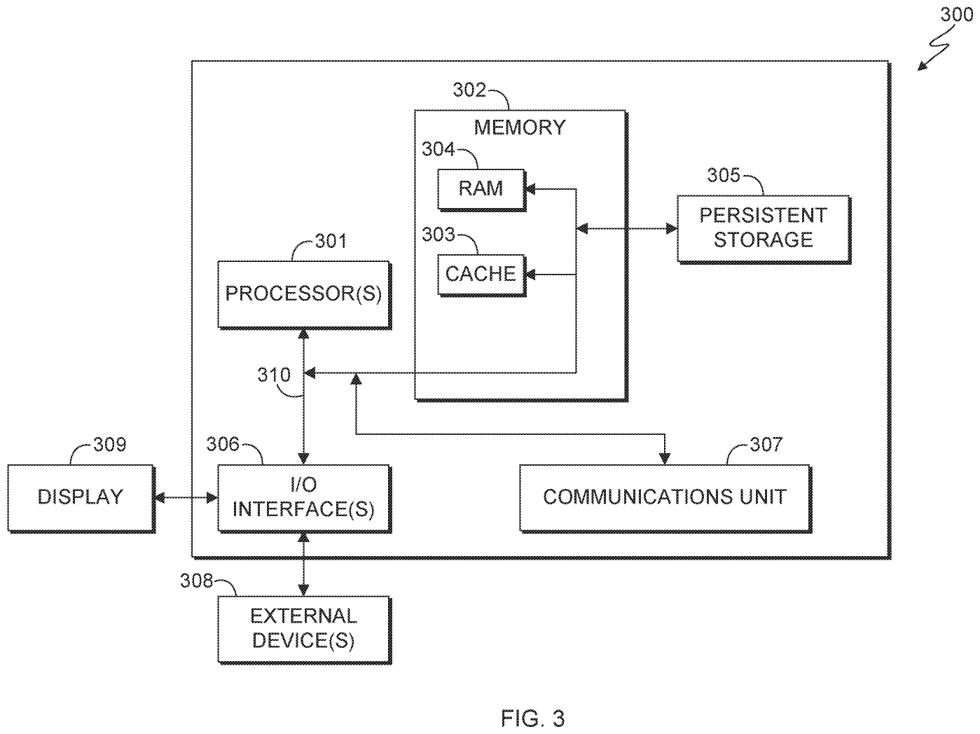

Computing device 110 may be any electronic device or computing system capable of processing program instructions and receiving and sending data. In some embodiments, computing device 110 may be a laptop computer, a tablet computer, a netbook computer, a personal computer (PC), a desktop computer, a personal digital assistant (PDA), a smart phone, or any programmable electronic device capable of communicating with network 102. In other embodiments, computing device 110 may represent a server computing system utilizing multiple computers as a server system, such as in a cloud computing environment. In general, computing device 110 is representative of any electronic device or combination of electronic devices capable of executing machine readable program instructions as described in greater detail with regard to FIG. 3, in accordance with embodiments of the present invention. Computing device 110 contains user display 112, database 122, and program 150.

User display 112 may be any electronic device or subsystem capable of augmented reality rendering, said may include optical projection systems, monitors, handheld devices, and display systems, which are worn on the human body. In an embodiment, user display 112 is a head-mounted display (HMD) is a display device worn on the forehead, such as a harness or helmet-mounted. HMDs place images of both the physical world and virtual objects over a field of view. In another embodiment, user display 112 is eyewear that employs cameras to intercept the real world view and re-display the augmented view through the eyepieces. In another embodiment, user display 112 is a head-up display (HUD) that has a transparent display that presents data without requiring users to look away from usual viewpoints. In yet another embodiment, user display 112 is a set contact lenses that display AR imaging.

Database 122 is a repository for data used by program 150. In the depicted embodiment, database 122 resides on computing device 110. In another embodiment, database 122 may reside on computing device 110 or elsewhere within distributed data processing environment 100 provided program 150 has access to database 122. A database is an organized collection of data. Database 122 can be implemented with any type of storage device capable of storing data and configuration files that can be accessed and utilized by program 150, such as a database server, a hard disk drive, or a flash memory. In an embodiment, database 122 stores data used by program 150, such as historical physical storage devices, associated filesystems, filesystem categories, filesystem security standards, historical physical storage visual identifiers, user preferences, etc.

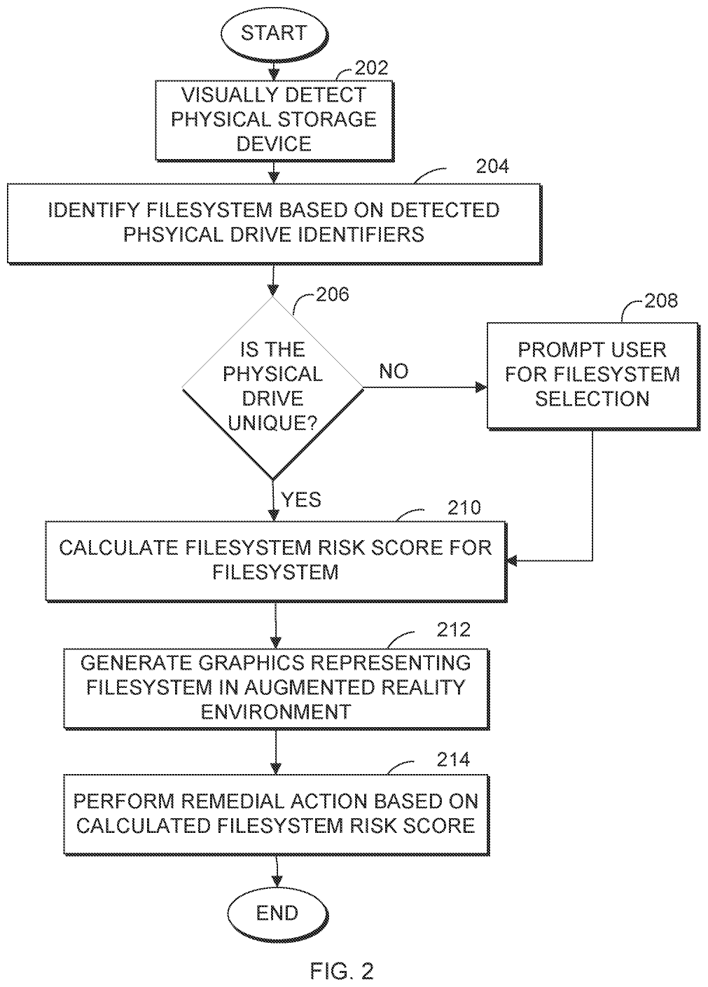

Program 150 is a program for risk of change analysis with visually captured physical storage devices. In various embodiments, program 150 may implement the following steps: detect a physical storage device within a visual proximity to a user within an augmented reality (AR) environment; capture one or more physical identifiers of the detected physical storage device; identify an indexed filesystem associated with the physical storage device utilizing the one or more captured physical identifiers, wherein the indexed filesystem contains metadata representing file content stored on the physical storage device; a filesystem risk score associated with the physical storage device utilizing the identified physical identifiers; and present generated graphics representing the indexed filesystem and the calculated filesystem risk score to the user within an AR viewport. In the depicted embodiment, program 150 is a standalone software program. In another embodiment, the functionality of program 150, or any combination programs thereof, may be integrated into a single software program. In some embodiments, program 150 may be located on separate computing devices (not depicted) but can still communicate over network 102. In various embodiments, client versions of program 150 resides on any other computing device (not depicted) within distributed data processing environment 100. Program 150 is depicted and described in further detail with respect to FIG. 2.

The present invention may contain various accessible data sources, such as database 122, that may include personal storage devices, data, content, or information the user wishes not to be processed. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Program 150 provides informed consent, with notice of the collection of personal data, allowing the user to opt in or opt out of processing personal data. Consent can take several forms. Opt-in consent can impose on the user to take an affirmative action before the personal data is processed. Alternatively, opt-out consent can impose on the user to take an affirmative action to prevent the processing of personal data before the data is processed. Program 150 enables the authorized and secure processing of user information, such as tracking information, as well as personal data, such as personally identifying information or sensitive personal information. Program 150 provides information regarding the personal data and the nature (e.g., type, scope, purpose, duration, etc.) of the processing. Program 150 provides the user with copies of stored personal data. Program 150 allows the correction or completion of incorrect or incomplete personal data. Program 150 allows the immediate deletion of personal data.

FIG. 2 depicts flowchart 200 illustrating operational steps of program 150 for risk of change analysis with visually captured physical storage devices, in accordance with an embodiment of the present invention.

Program 150 visually detects a physical storage device (step 202). In another embodiment, program 150 initiates responsive to a new physical storage device inclusion on a monitored enterprise system or network. In an example, a user connects a removable hard drive containing a filesystem, comprising financial data, onto a monitored computer. Here, program 150 responsively indexes the filesystem, categorizes the filesystem, retrieves related security standards associated with the filesystem, and associates one or more physical identifiers, associated with the physical storage device, with the indexed filesystem. In this embodiment, physical identifiers include, but are not limited to, physical storage device color, physical storage device branding, physical storage device dimensions (e.g., width, length, generalized shape, design, etc.), physical storage device condition (e.g., physical damage, corrosion, color variations), physical storage device service duration, physical storage device location, etc. In these embodiments, the indexed filesystem contains metadata representing file content or data stored on the physical storage device. In a further embodiment, metadata associated with the indexed filesystem contains file/folder structure information, data modification information (e.g., addition, modification, removal of data), data categories, associated user information and permissions, last known location, etc.

In an embodiment, program 150 verifies the physical identifiers of the physical storage device associated with a newly indexed filesystem, where program 150 verifies the uniqueness of the physical storage device such that program 150 can readily visually identify said physical storage device in an augmented reality (AR) environment. In this embodiment, program 150 sends an alteration prompt or suggestion to the user in order to have the user modify the physical storage device (e.g., physical identifiers), allowing program 150 future visual recognition of the physical storage device. Here, program 150 utilizes physical identifiers associated with in-use (i.e., actively monitored) physical storage devices when advising the user regarding which alterations to make. In an embodiment, program 150 bypasses the user and makes the alterations to the physical storage device. For example, program 150 utilizes an automated engraving tool to create a unique pattern of physical identifiers for the physical storage device.

In the embodiments above, program 150 updates the indexed filesystem responsive to the physical storage device connecting onto a monitored computing device. In an embodiment, program 150 establishes a web hook that triggers responsive to a subsequent physical pairing of the physical storage device. Responsive to the subsequent physical pairing of the physical storage device, program 150 activates the web hook to identify an associated captured indexed filesystem. Responsively, the indexed filesystem is overwritten with the metadata of the current set of data on the physical storage device. In an embodiment, program 150 remits the indexed filesystem and physical identifiers associated to the physical storage device to a cloud/local image storage system (i.e., database 122), while capturing a snapshot of the filesystem and physical identifiers of the physical storage device. In a further embodiment, this overwriting action commits the filesystem changes and change history to database 122. In another embodiment, responsive to a plurality of filesystems paired with a web hook with no clear differentiating identifiers, program 150 stores each filesystem in parallel instead of overwriting the stored indexed filesystem.

In an embodiment, program 150 initiates responsive to a user action such as turning on or wearing an associated AR system, user voice command, detection of a physical storage device in a proximity to a user, etc. Program 150 visually detects a disconnected or unplugged physical storage device within a visual proximity to computing device 110. In an embodiment, program 150 utilizes computer vision to identify one or more physical storage devices in a proximity to computing device 110. In an embodiment, program 150 utilizes computer vision to derive meaningful information (i.e., physical storage drive identifiers) from visual inputs comprising the detected physical storage drive. In this embodiment, program 150 identifies or captures a plurality of physical identifiers associated with the detected physical storage device.

Program 150 identifies a filesystem based on detected physical storage drive identifiers (step 204). In an embodiment, program 150 utilizes a convolutional neural network (CNN) to identify a filesystem associated with the detected physical storage device utilizing the physical identifiers described in step 202. In this embodiment, the CNN is trained to provide filesystem predictions and probabilities when inputted with labeled physical identifiers, wherein the physical identifiers are labeled with physical storage device and associated filesystem. In this embodiment, the CNN performs a series of convolutions and predicts the physical storage device. Responsive to one or more predicted physical storage devices, program 150 retrieves metadata representing the filesystem associated with the physical storage system. In this embodiment, program 150 requests the metadata based on foreign key association with database 122 utilizing physical identifiers.

If the physical drive is not unique (“no” branch, decision block 206), then program 150 prompts a user for a filesystem selection (step 208). Responsive to program 150 identifying a plurality of filesystems that could correspond to the physical storage device, program 150 presents a list of metadata (e.g., indexed filesystem) associated with each filesystem in the plurality of filesystems to a user utilizing user display 112. In this embodiment, program 150 tailors the presented metadata to only include allowed information subject to security standards associated with each filesystem and security restrictions imposed on the user. For example, program 150 obscures metadata that the user does not have permission or sufficient privileges to view. In this embodiment, program 150 incorporates the probabilities ascertained from the CNN utilized in step 204. For example, program 150 computes a probability of 85% that a specific filesystem corresponds to a particular detected physical storage drive and associated physical identifiers. In these embodiments, program 150 prompts the user for a filesystem selection. Responsive to the user selection, program 150 associates or reinforces the physical storage device with the filesystem.

If the physical drive is unique (“yes” branch, decision block 206), then program 150 calculates a filesystem risk score for the filesystem (step 210). Responsive to program 150 identifying a unique filesystem or a user selected filesystem corresponding to the physical storage device, program 150 calculates the filesystem risk score for the filesystem. In an embodiment, the filesystem risk score is a value or probability representing the likelihood that the data or contents with the filesystem associated with the physical storage device has been modified or altered. In an embodiment, program 150 calculates the filesystem risk score utilizing historical physical identifiers associated with the physical storage device and captured from repeated visual detections, as described in step 202. In this embodiment, program 150 calculates the filesystem risk score based on the level of physical change between the current state of the physical storage device and historical states of the physical storage device (i.e., historical physical identifiers). For example, program 150 detects that the physical storage device has significant physical damage as compared to the last known condition of the physical storage device, responsively program 150 increases the filesystem risk score. In another embodiment, program 150 incorporates comparisons of the current location and historical locations of the physical storage device. For example, program 150 increases the filesystem risk score if the physical storage device has traveled a predetermined distance (e.g., 5 miles) from the last known location of the physical storage device.

In another embodiment, program 150 utilizes a heuristic approach for filesystem risk calculation, defining a risk score as a value of change based on expected data compared to actual data. In this embodiment, program 150 incorporates an internal block tree version history, representing historical indexed filesystems. The internal block tree is contained within filesystem metadata and defined as a data structure containing each data block with a cryptographic hash of at least one previous block from one or more historical indexed filesystems. In another embodiment, if the calculated filesystem risk score based on block tree version is high (i.e., meets or exceeds a risk threshold), then program 150 confirms the physical storage device has been altered. In another embodiment, if filesystem risk score is low (i.e., fails to exceed a risk threshold), the system confirms that the physical storage device is robust (i.e., within security standards or practices).

Program 150 generates graphics representing the filesystem in an augmented reality environment (step 212). In an embodiment, program 150 generates one or more graphics representing the file system for an AR viewport or user interface. For example, program 150 generates a graphical ring that will be superimposed upon the physical storage device in an AR environment. In an embodiment, program 150 presents the generated graphics for the identified filesystem to the user via user display 112. In an embodiment, program 150 retrieves, queries, prompts, or determines user preferences or settings detailing user preferred graphics presentation settings such as level of transparency and text color preferences. In another embodiment, program 150 modifies, transforms, or adjusts one or more graphical elements including, but not limited to, font, font size, character style, font color, background color, capitalizations, general transparency, and relative transparency, of user display 112. For example, program 150 presents an AR based circle surrounding (i.e., in a proximity) the physical storage device within the AR viewport of the user. In an embodiment, program 150 adjusts the stylistic elements of the presented physical storage device based on the calculated risk score. For example, program 150 highlights the present physical storage device in red responsive to a high filesystem risk score. In an embodiment, program 150 receives an auditory user request or a textually query for a given file within a filesystem. In this embodiment, program 150 highlights the relevant physical storage device within the AR viewport of the user. In a further embodiment, program 150 includes audio feedback instructions to assist the user in identifying the correct physical storage device. In an embodiment, program 150 utilizes the indexed filesystem to locate physical storage devices containing one or more files. In an embodiment, program 150 responds to acoustic user requests, such as “which device has been modified”. In this embodiment, program 150 presents a calculated risk score level for each physical storage device within a visual proximity to the user. 13

Program 150 performs a remedial action based on the calculated filesystem risk score (step 214). In an embodiment, program 150 performs a remedial action on the indexed filesystem and associated physical storage device based on the calculated filesystem risk score exceeding a risk threshold (i.e., high risk). For example, program 150 schedules the physical storage device to be deleted or wiped responsive to connecting the physical storage device to a monitored computing device. In another example, program 150 alerts administrators with the location and condition (e.g., filesystem risk score, filesystem category, filesystem importance, etc.) of the physical storage device based on the calculated filesystem risk score.

In an exemplary embodiment, a user owns two distinct physical storage devices, one containing medical data and the other containing financial data. The user transmits a voice query to program 150, asking for the location of the physical storage device with medical data. Program 150, responsively, presents the user with an arrow highlighting the location of the physical storage device with medical data within the AR viewport of the user. In addition, program 150 transmits a textual message to the user with the physical identifiers associated with the physical storage device. The user also requests to view “all filesystems that have been altered” (i.e., high filesystem risk score), responsively, program 150 highlights all filesystems, within a visual AR proximity, that have associated filesystem risk scores that exceed a risk threshold. Additionally, program 150 schedules the high risk physical storage device to be quarantined the next time said device connects to a monitor computing device or network.

FIG. 3 depicts block diagram 300 illustrating components of computing device 110 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computing device 110 includes communications unit 307, which provides communications between cache 303, memory 302, persistent storage 305, communications fabric 310, and input/output (I/O) interface(s) 306. Communications fabric 310 can be implemented with any architecture designed for passing data and/or control information between processors (such as microprocessors, communications, and network processors, etc.), system memory, peripheral devices, and any other hardware components within a system. For example, communications fabric 310 can be implemented with one or more buses or a crossbar switch.

Memory 302 and persistent storage 305 are computer readable storage media. In this embodiment, memory 302 includes random access memory (RAM) 304. In general, memory 302 can include any suitable volatile or non-volatile computer readable storage media. Cache 303 is a fast memory that enhances the performance of computer processor(s) 301 by holding recently accessed data, and data near accessed data, from memory 302.

Program 150 may be stored in persistent storage 305 and in memory 302 for execution by one or more of the respective computer processor(s) 301 via cache 303. In an embodiment, persistent storage 305 includes a magnetic hard disk drive. Alternatively, or in addition to a magnetic hard disk drive, persistent storage 305 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305. Software and data can be stored in persistent storage 305 for access and/or execution by one or more of the respective processors 301 via cache 303.

Communications unit 307, in these examples, provides for communications with other data processing systems or devices. In these examples, communications unit 307 includes one or more network interface cards. Communications unit 307 may provide communications through the use of either or both physical and wireless communications links. Program 150 may be downloaded to persistent storage 305 through communications unit 307.

I/O interface(s) 306 allows for input and output of data with other devices that may be connected, respectively, to computing device 110. For example, I/O interface(s) 306 may provide a connection to external device(s) 308, such as a keyboard, a keypad, a touch screen, and/or some other suitable input device. External devices 308 can also include portable computer readable storage media such as, for example, thumb drives, portable optical or magnetic disks, and memory cards. Software and data used to practice embodiments of the present invention, e.g., program 150, can be stored on such portable computer readable storage media and can be loaded onto persistent storage 305 via I/O interface(s) 306. I/O interface(s) 306 also connect to a display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, conventional procedural programming languages, such as the “C” programming language or similar programming languages, and quantum programming languages such as the “Q” programming language, Q#, quantum computation language (QCL) or similar programming languages, low-level programming languages, such as the assembly language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
detecting, by one or more computer processors, a physical storage device within a visual proximity to a user within an augmented reality (AR) environment;
capturing, by one or more computer processors, one or more physical identifiers of the detected physical storage device;
identifying, by one or more computer processors, an indexed filesystem associated with the physical storage device utilizing the one or more captured physical identifiers, wherein the indexed filesystem contains metadata representing file content stored on the physical storage device;
calculating, by one or more computer processors, a filesystem risk score associated with the physical storage device utilizing the identified physical identifiers; and
presenting, by one or more computer processors, generated graphics representing the indexed filesystem and the calculated filesystem risk score to the user within an AR viewport.

2. The computer-implemented method of claim 1, wherein calculating the filesystem risk score associated with the physical storage device utilizing the identified physical identifiers, comprises:
calculating, by one or more computer processors, the filesystem risk score utilizing an internal block tree, wherein the internal block tree is defined as a data structure containing a cryptographic hash of at least one previous block from one or more historical indexed filesystems.

3. The computer-implemented method of claim 1, wherein calculating the filesystem risk score associated with the physical storage device utilizing the identified physical identifiers, comprises:
calculating, by one or more computer processors, the filesystem risk score based on a level of physical change between a current state of the physical storage device and historical states of the physical storage device.

4. The computer-implemented method of claim 1, further comprising:
responsive to exceeding a filesystem risk score threshold, scheduling, by one or more computer processors, the physical storage device to be deleted when connected to a monitored computing device.

5. The computer-implemented method of claim 1, further comprising:
presenting, by one or more computer processors, the indexed filesystem based on an auditory user request for a location of a file in the AR environment.

6. The computer-implemented method of claim 1, wherein the filesystem risk score is a value or probability representing a likelihood that data contained within the physical storage device has been modified.

7. The computer-implemented method of claim 1, further comprising:
verifying, by one or more computer processors, physical identifier uniqueness of the physical storage device.

8. A computer program product comprising:
one or more computer readable storage media and program instructions stored on the one or more computer readable storage media, the stored program instructions comprising:
program instructions to detect a physical storage device within a visual proximity to a user within an augmented reality (AR) environment;
program instructions to capture one or more physical identifiers of the detected physical storage device;
program instructions to identify an indexed filesystem associated with the physical storage device utilizing the one or more captured physical identifiers, wherein the indexed filesystem contains metadata representing file content stored on the physical storage device;
program instructions to calculate a filesystem risk score associated with the physical storage device utilizing the identified physical identifiers; and
program instructions to present generated graphics representing the indexed filesystem and the calculated filesystem risk score to the user within an AR viewport.

9. The computer program product of claim 8, wherein the program instructions to calculate the filesystem risk score associated with the physical storage device utilizing the identified physical identifiers, comprise:
program instructions to calculate the filesystem risk score utilizing an internal block tree, wherein the internal block tree is defined as a data structure containing a cryptographic hash of at least one previous block from one or more historical indexed filesystems.

10. The computer program product of claim 8, wherein the program instructions to calculate the filesystem risk score associated with the physical storage device utilizing the identified physical identifiers, comprise:
program instructions to program instructions to calculate the filesystem risk score based on a level of physical change between a current state of the physical storage device and historical states of the physical storage device.

11. The computer program product of claim 8, wherein the program instructions, stored on the one or more computer readable storage media, further comprise:
program instructions to responsive to exceeding a filesystem risk score threshold, schedule the physical storage device to be deleted when connected to a monitored computing device.

12. The computer program product of claim 8, wherein the program instructions, stored on the one or more computer readable storage media, further comprise:
program instructions to present the indexed filesystem based on an auditory user request for a location of a file in the AR environment.

13. The computer program product of claim 8, wherein the filesystem risk score is a value or probability representing a likelihood that data contained within the physical storage device has been modified.

14. The computer program product of claim 8, wherein the program instructions, stored on the one or more computer readable storage media, further comprise:
program instructions to verify physical identifier uniqueness of the physical storage device.

15. A computer system comprising:
one or more computer processors;
one or more computer readable storage media; and
program instructions stored on the computer readable storage media for execution by at least one of the one or more processors, the stored program instructions comprising:
program instructions to detect a physical storage device within a visual proximity to a user within an augmented reality (AR) environment;
program instructions to capture one or more physical identifiers of the detected physical storage device;
program instructions to identify an indexed filesystem associated with the physical storage device utilizing the one or more captured physical identifiers, wherein the indexed filesystem contains metadata representing file content stored on the physical storage device;
program instructions to calculate a filesystem risk score associated with the physical storage device utilizing the identified physical identifiers; and
program instructions to present generated graphics representing the indexed filesystem and the calculated filesystem risk score to the user within an AR viewport.

16. The computer system of claim 15, wherein the program instructions to calculate the filesystem risk score associated with the physical storage device utilizing the identified physical identifiers, comprise:
program instructions to calculate the filesystem risk score utilizing an internal block tree, wherein the internal block tree is defined as a data structure containing a cryptographic hash of at least one previous block from one or more historical indexed filesystems.

17. The computer system of claim 15, wherein the program instructions to calculate the filesystem risk score associated with the physical storage device utilizing the identified physical identifiers, comprise:
program instructions to program instructions to calculate the filesystem risk score based on a level of physical change between a current state of the physical storage device and historical states of the physical storage device.

18. The computer system of claim 15, wherein the program instructions, stored on the one or more computer readable storage media, further comprise:
program instructions to responsive to exceeding a filesystem risk score threshold, schedule the physical storage device to be deleted when connected to a monitored computing device.

19. The computer system of claim 15, wherein the program instructions, stored on the one or more computer readable storage media, further comprise:
program instructions to present the indexed filesystem based on an auditory user request for a location of a file in the AR environment.

20. The computer system of claim 15, wherein the program instructions, stored on the one or more computer readable storage media, further comprise:
program instructions to verify physical identifier uniqueness of the physical storage device.
